(19) United States
(12) Patent Application Publication
(10) Pub. No.: US 2026/0137024 A1
(43) Pub. Date: May 21, 2026

(54) UNMANNED RADISH HARVESTING SYSTEM

(71) Applicant: Information Technology Research Center, Beijing Academy of Agriculture and Forestry Sciences, Beijing (CN)

(72) Inventors: Huarui WU, Beijing (CN); Wang GUO, Beijing (CN); Youlin CUI, Beijing (CN); Wei GUO, Beijing (CN); Peng HAO, Beijing (CN)

(21) Appl. No.: 19/388,715

(22) Filed: Nov. 13, 2025

(30) Foreign Application Priority Data
Nov. 15, 2024 (CN) 202411637374.4

(51) Int. Cl. A01D 27/00

(52) U.S. Cl. CPC A01D 27/00

(57) ABSTRACT

Provided is an unmanned radish harvesting system, relating to the field of agricultural artificial intelligence technologies. The system, using an unmanned radish harvesting control subsystem, an unmanned radish harvesting operation subsystem, and a radish agronomic parameter configuration subsystem, allows for intelligent control of the movement of a radish harvester and optimal operation path planning by integrating the shape and terrain of a vegetable field plot and planting agronomic practices. On the basis of various parameter configurations, a computer vision algorithm is employed to accurately identify radish fruits and radish tops. The unmanned radish harvesting system realizes more intelligent, delicate, and accurate operations of the unmanned radish harvester, thereby saving human resources, material resources, and time, and improving the efficiency and quality of unmanned radish harvesting as well as the green and intelligent levels of unmanned radish harvesting.

### CROSS REFERENCE TO RELATED APPLICATION

This patent application claims the benefit and priority of Chinese Patent Application No. 2024116373744, filed with the China National Intellectual Property Administration on Nov. 15, 2024, the disclosure of which is incorporated by reference herein in its entirety as part of the present application.

### TECHNICAL FIELD

The present disclosure relates to the field of agricultural artificial intelligence technologies, and in particular, to an unmanned radish harvesting system.

### BACKGROUND

Radish is a root vegetable with high edible and medicinal values. The harvesting process is the most time-consuming and labor-intensive procedure, typically involving digging, soil loosening, conveying, top cutting, transportation, and the like.

In the prior art, harvesters for intelligently harvesting radishes have primarily addressed the intelligentization problem of some steps of mechanized combined harvesting of radishes, achieving operational continuity in gathering, clamping and pulling, conveying, and cutting of radishes. While these harvesters are structurally adapted to radish production environments, they often require collaboration between at least two individuals in the harvesting process and demand high expertise from both harvesting and sorting personnel, making fully unmanned intelligent harvesting unattainable. Moreover, in case of hot weather, using existing harvesters for radish harvesting places extremely high requirements on the physical strength and energy of drivers, resulting in significant consumption of labor, resources, and time.

### SUMMARY

The present disclosure provides an unmanned radish harvesting system to solve the aforementioned problems existing in the prior art.

The present disclosure provides an unmanned radish harvesting system, including an unmanned radish harvesting control subsystem, an unmanned radish harvesting operation subsystem, and a radish agronomic parameter configuration subsystem,
where the unmanned radish harvesting control subsystem includes an unmanned movement control module and an unmanned radish harvesting module; the unmanned movement control module is mainly composed of a remote control module, a wireless communication system, a Beidou satellite positioning system, and an electric tracked chassis; the unmanned radish harvesting module is configured to control a height using an included angle sensor and deduce heights of an operation platform and a ridge from an included angle between the operation platform and the ridge;
the unmanned radish harvesting operation subsystem includes a ridge alignment navigation and extraction module and a U-turn and row switching module; the ridge alignment navigation and extraction module includes a real-time kinematic (RTK) module configured to apply mapping information in harvesting operation by utilizing radish agronomic parameter information to realize position recognition of radishes, and a visual module configured to align ridges through identification of furrow edge information and realize real-time operation path planning; the U-turn and row switching module is configured to plan a path to a farm track, an edge of a field, and an edge of an operation plot during operation; and
the radish agronomic parameter configuration subsystem includes a cultivar parameter configuration module configured to obtain cultivar parameter configuration information, a cultivation parameter configuration module configured to obtain cultivation parameter configuration information, and an environmental parameter configuration module configured to obtain environmental parameter configuration information.

According to the unmanned radish harvesting system provided by the present disclosure, the unmanned movement control module includes an unmanned velocity control module and an unmanned steering control module; the unmanned velocity control module is configured for soft voltage regulation and control in the form of a steering engine; and the unmanned steering control module is controlled by using a proportional valve.

According to the unmanned radish harvesting system provided by the present disclosure, the U-turn and row switching module is configured for path optimization using an elite ant colony algorithm.

According to the unmanned radish harvesting system provided by the present disclosure, the unmanned radish harvesting operation subsystem includes a clamping-pulling visual recognition module configured to obtain radish fruits by using an instance segmentation algorithm.

According to the unmanned radish harvesting system provided by the present disclosure, a Yolov8s-seg model is used as a backbone network of a segmentation network of the instance segmentation algorithm; MobileNetv4 is used as a backbone of the Yolov8s-seg model; a spatial pyramid pooling-fast (SPPF) module in the Yolov8s-seg model is replaced with a large separable kernel attention module; and the segmentation network includes an inverted bottleneck search module.

According to the unmanned radish harvesting system provided by the present disclosure, the visual module is configured to binarize a captured image separately using Hough operator and Otsu's method with adaptive thresholding, process a loss function based on Huber algorithm, and identify a center line of a ridge and boundaries on two sides of the ridge during radish harvesting.

According to the unmanned radish harvesting system provided by the present disclosure, the unmanned radish harvesting system further includes an edge server and a cloud server,
where a cloud-edge-terminal intelligent service architecture is adopted for the unmanned radish harvesting system; the unmanned radish harvesting control subsystem and the unmanned radish harvesting operation subsystem are implemented by terminals; and big data processing is performed by the edge server and/or the cloud server.

According to the unmanned radish harvesting system provided by the present disclosure, the cultivation parameter configuration information includes one or more of:
an overall operation area configuration;
a planting ridge height;
a ridge spacing;
a row spacing;
a plant spacing; and
a cultivation time.

According to the unmanned radish harvesting system provided by the present disclosure, the cultivar parameter configuration information includes one or more of:
a radish cultivar;
a fruit size;
a ripening time;
a water requirement for different stages;
a fertilizer requirement for different stages;
a suitable temperature; and
a suitable humidity.

According to the unmanned radish harvesting system provided by the present disclosure, the environmental parameter configuration information includes one or more of:
an air temperature;
an air humidity;
a soil temperature;
a soil humidity;
illumination; and
a soil pH.

The unmanned radish harvesting system provided by the present disclosure, using the unmanned radish harvesting control subsystem, the unmanned radish harvesting operation subsystem, and the radish agronomic parameter configuration subsystem, allows for intelligent control of the movement of a radish harvester and optimal operation path planning by integrating the shape and terrain of a vegetable field plot and planting agronomic practices. On the basis of various parameter configurations, a computer vision algorithm is employed to accurately identify radish fruits and radish tops. The unmanned radish harvesting system realizes more intelligent, delicate, and accurate operations of the unmanned radish harvester, thereby saving human resources, material resources, and time, and improving the efficiency and quality of unmanned radish harvesting as well as the green and intelligent levels of unmanned radish harvesting.

### BRIEF DESCRIPTION OF THE DRAWINGS

To describe the technical solutions in the present disclosure or in the prior art more clearly, the following briefly describes the accompanying drawings required for describing the embodiments or the prior art. Apparently, the accompanying drawings in the following description show some embodiments of the present disclosure, and a person skilled in the art may still derive other accompanying drawings from these accompanying drawings without creative efforts.

FIG. 1 is a schematic diagram of a technical architecture of an unmanned radish harvesting system provided by the present disclosure;

FIG. 2 is a schematic diagram of intelligent transformation of a radish harvester in an unmanned radish harvesting system provided by the present disclosure;

FIG. 3 is a schematic diagram of differential track tracking in an unmanned radish harvesting system provided by the present disclosure;

FIGS. 4A-4C are schematic diagrams of a power module of a tracked chassis in an unmanned radish harvesting system provided by the present disclosure;

FIG. 5 is a schematic diagram of radish path planning in an unmanned radish harvesting system provided by the present disclosure;

FIG. 6 is a schematic diagram of an elite ant colony algorithm in an unmanned radish harvesting system provided by the present disclosure;

FIG. 7 is a schematic diagram of an improved Yolov8s-seg network structure in an unmanned radish harvesting system provided by the present disclosure; and

FIG. 8 is a schematic diagram of a cloud-edge-terminal intelligent processing architecture for radish harvesting in an unmanned radish harvesting system provided by the present disclosure.

### DETAILED DESCRIPTION OF THE EMBODIMENTS

Radish is a root vegetable with extremely high edible and medicinal values. At present, it has a large planting area. The harvesting process is the most time-consuming and labor-intensive procedure, typically involving digging, soil loosening, conveying, top cutting, transportation, and the like.

Existing intelligent harvesting machines for radishes, such as radish harvesters or combined radish harvesters, can perform deep soil loosening, leaf raking, top pulling, radish conveying, and fruit separation and cutting during the harvesting process, thereby realizing multi-functional combined radish harvesting operations and exhibiting high scenario adaptability. However, during the radish harvesting process, a driver needs to focus on the radish clamping and pulling side for a long time, and also needs to check whether the radish fruits are cut. These machines have not undergone unmanned transformation, and often lack systematic connection as a whole, as well as expansion in terms of intelligent electronic control and automatic control.

Therefore, the prior art has primarily addressed the intelligentization problem of some steps of mechanized combined harvesting of harvesting, and have achieved operational continuity in gathering, clamping and pulling, conveying, and cutting of radishes. While these harvesters are structurally adapted to radish production environments, the harvesting process requires collaboration between at least two individuals and demands high expertise from both harvesting and sorting personnel. Even if intelligent transformation is carried out on partial parts and methods for avoiding fruit damage during radish harvesting are provided, it is still necessary to rely on the quality of the clamping and pulling operation using a gathering device, and it is impossible to realize completely intelligent harvesting. Especially in hot weather, the requirements for the driver's physical strength and energy are extremely high.

On this basis, an unmanned radish harvesting system provided in the present disclosure achieves the combination of radish producing agronomic practices, various radish harvesting agricultural machinery, and data collected during the operation process. Unmanned transformation can be carried out based on a radish harvester. The forward and backward movements, direction, and velocity of the harvester, and the lifting of a harvesting arm are intelligently defined. By integrating the shape and terrain of a vegetable field plot and planting agronomic practices, optimal operation path planning is performed to save fuel consumption, thereby protecting the micro-environment of the vegetable field, and integrating the concept of green production into an unmanned driving model.

Furthermore, the unmanned radish harvesting system provided in the present disclosure has a computer vision algorithm integrated in a plurality of processes to accurately identify radish fruits and radish tops. More intelligent and delicate operations of the harvester by an unmanned operation model are realized, and support is provided for the development of new-quality productive forces in the vegetable industry.

To make the objectives, technical solutions and advantages of the present disclosure clearer, the following clearly and completely describes the technical solutions in the present disclosure with reference to the accompanying drawings in the present disclosure. Apparently, the described embodiments are some but not all of the embodiments of the present disclosure. All other embodiments obtained by those of ordinary skill in the art based on the embodiments of the present disclosure without creative efforts should fall within the protection scope of the present disclosure.

The unmanned radish harvesting system provided in the present disclosure presents unmanned transformation with respect to radish harvesting operation equipment, and an overall transformation method covering a power module, a direction control module, a harvesting operation module, a path planning module, a precise ridge alignment module, and a fruit recognition module is proposed, which is adapted to the scenario of standardized planting and unmanned harvesting of radishes. All models that have been transformed for unmanned operation use the cloud-edge-terminal processing architecture, and the computing power overhead is minimized through scenario-based adaptive scheduling of the models. In the harvesting operation process, the path planning, precise ridge alignment, and fruit recognition modules each take the need to save fuel consumption and power consumption from the aspects of the shortest path and the optimal computing power into account. While realizing unmanned operation, carbon emissions can be reduced, promoting the realization of green, efficient, and intelligent vegetable production.

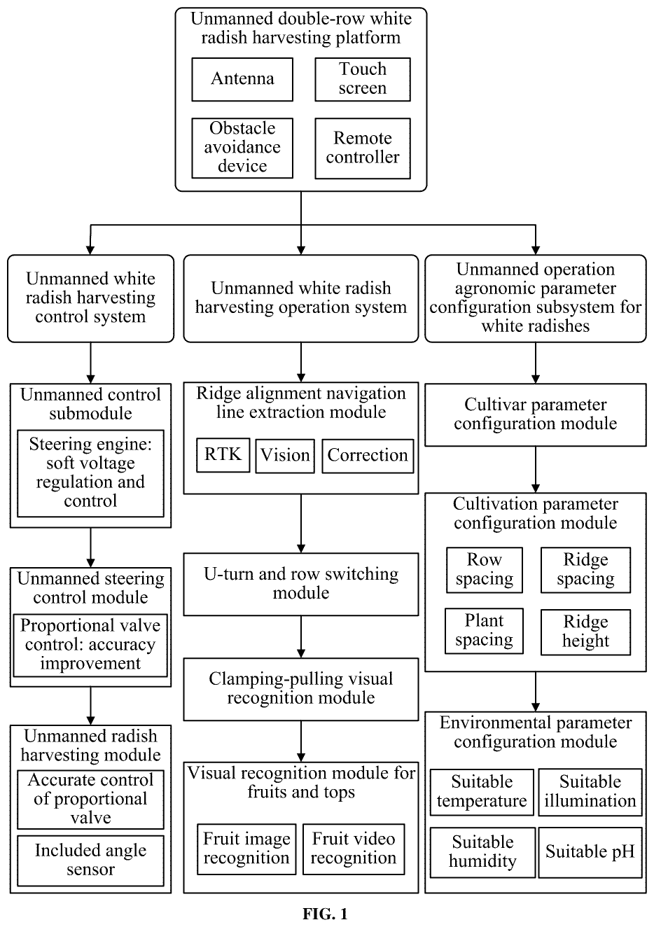

The unmanned radish harvesting system of the present disclosure is described below with reference to FIG. 1 to FIG. 8.

FIG. 1 is a schematic diagram of a technical architecture of an unmanned radish harvesting system provided by the present disclosure. As shown in FIG. 1, the system includes an unmanned radish harvesting control subsystem, an unmanned radish harvesting operation subsystem, and a radish agronomic parameter configuration subsystem.

The unmanned radish harvesting control subsystem includes an unmanned movement control module and an unmanned radish harvesting module. The unmanned movement control module is mainly composed of a remote control module, a wireless communication system, a Beidou satellite positioning system, and an electric tracked chassis. The unmanned radish harvesting module is configured to control a height using an included angle sensor and deduce heights of an operation platform and a ridge from an included angle between the operation platform and the ridge.

The unmanned radish harvesting operation subsystem includes a ridge alignment navigation and extraction module and a U-turn and row switching module. The ridge alignment navigation and extraction module includes an RTK module configured to apply mapping information in harvesting operation by utilizing radish agronomic parameter information to realize position recognition of radishes, and a visual module configured to align ridges through identification of furrow edge information and realize real-time operation path planning. The U-turn and row switching module is configured to plan a path to a farm track, an edge of a field, and an edge of an operation plot during operation.

The radish agronomic parameter configuration subsystem includes a cultivar parameter configuration module configured to obtain cultivar parameter configuration information, a cultivation parameter configuration module configured to obtain cultivation parameter configuration information, and an environmental parameter configuration module configured to obtain environmental parameter configuration information.

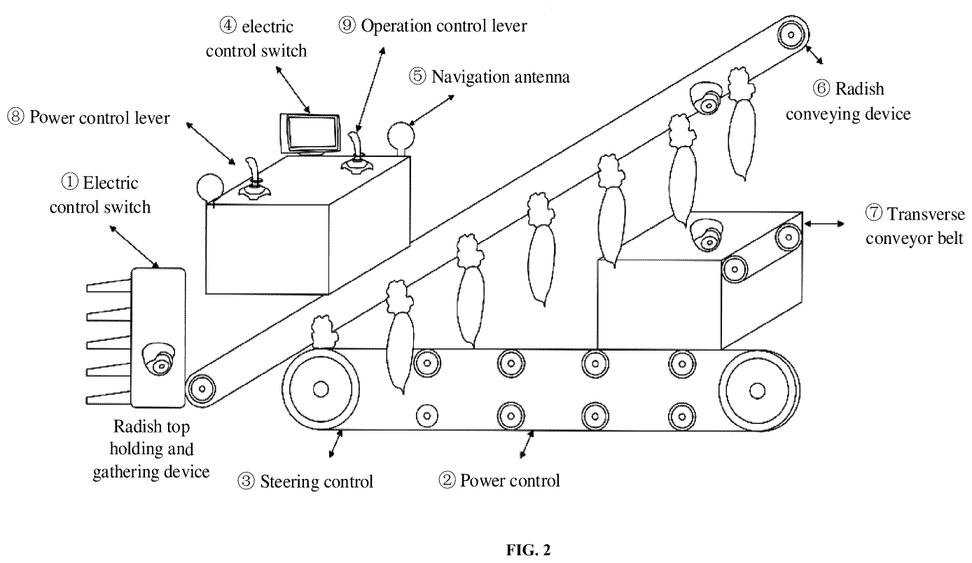

In particular, the unmanned radish harvesting system of the present disclosure is illustrated by taking harvesting white radishes as an example in the embodiments of the present disclosure. FIG. 2 is a schematic diagram of intelligent transformation of a radish harvester in an unmanned radish harvesting system provided by the present disclosure. The radish harvester in the unmanned radish harvesting system provided by an embodiment of the present disclosure is based on a clamping-type radish harvester, and has a basic structure including a double-row radish top holding device, a fruit cutting device, a tracked power device, a radish fruit conveying device, a transverse conveyor belt, a driving control cabin, a radish top holding electric control switch, a forward-backward power control lever, and a harvesting operation control lever for adjusting the direction of the radish harvester and the up-and-down movement of the harvesting arm. A radish harvesting platform is equipped with navigation antennas, a millimeter-wave radar, a lidar, a binocular camera, and a touch screen, where the navigation antennas are spaced 1 meter apart at the same height; the touch screen provides an intelligent control entry for the radish harvester; and multi-modal data from the millimeter-wave radar, the lidar, and the binocular camera is fused for mapping and obstacle avoidance. All the control levers are connected to an electric control module of a steering engine so as to control the traveling direction and velocity of the operation platform as well as the raising and lowering of the radish harvesting arm. Based on this, unmanned transformation and upgrading are carried out.

The unmanned transformation of the radish harvesting equipment (i.e., the radish harvester) provided in the embodiment of the present disclosure allows for integration and application of the electronic control technology, the Beidou navigation technology, the computer vision recognition technology, and the control feedback technology to power control of the radish harvesting equipment, operation implement control, operation path planning, precise row alignment, and fruit cutting, and systematic adaptation is achieved.

Optionally, the unmanned movement control module includes an unmanned velocity control module and an unmanned steering control module. The unmanned velocity control module is configured for soft voltage regulation and control in the form of a steering engine. The unmanned steering control module is controlled by using a proportional valve.

Specifically, the unmanned velocity control module is configured for soft voltage regulation and control in the form of the steering engine, making the travel of the radish harvester more stable and reducing vibration during velocity changes.

The unmanned steering control module is controlled by using the proportional valve such that the accuracy of steering control is improved, thereby facilitating flexible turning of the radish harvester.

The unmanned steering control module is mainly composed of a remote control module, a wireless communication system, a Beidou satellite positioning system, and an electric tracked chassis.

The radish harvester can monitor obstacles in real time during traveling and reversing through fused recognition by the millimeter-wave radar, the lidar, and a visual sensor.

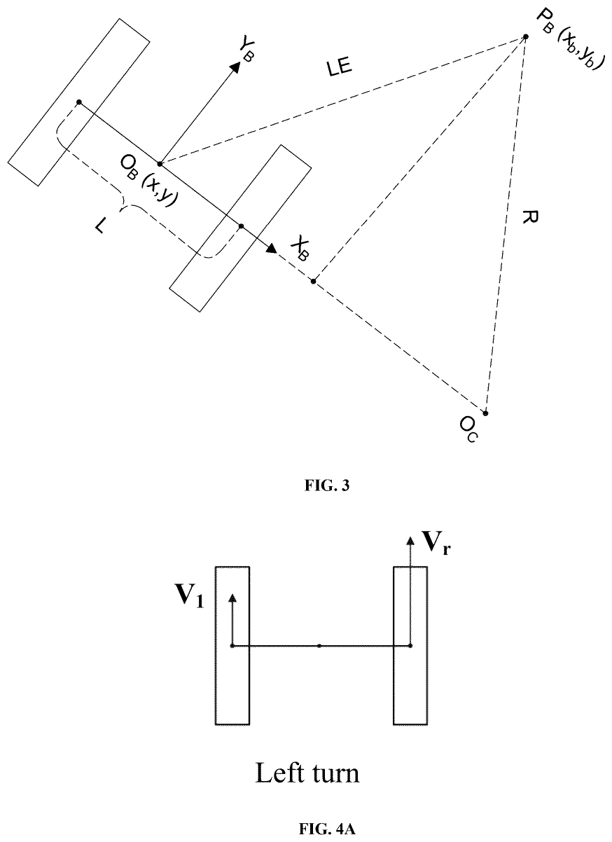

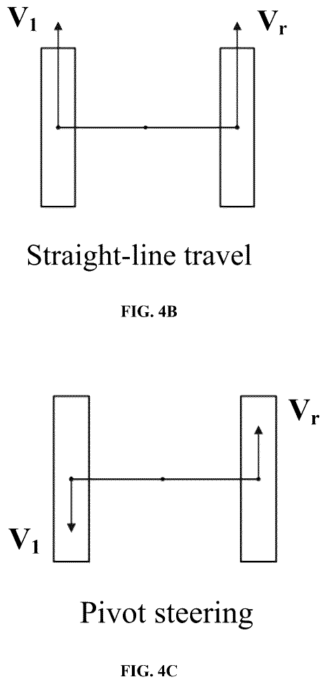

In an embodiment of the present disclosure, to realize the automatic path control by the tracked chassis of the radish harvester during the radish harvesting process, it is necessary to define the pose of the radish harvester during its travel. FIG. 3 is a schematic diagram of differential track tracking in an unmanned radish harvesting system provided by the present disclosure. A track center of the radish harvester is taken as a base point of coordinates of motion. A center point of the tracked chassis is denoted by O_{B} (x, y), and a velocity denoted by v, a velocity of a left track denoted by vₗ, and a velocity of a right track denoted by vᵣ. An included angle θ between a direction of the velocity at the point O_{B} and the positive direction of the x-axis of a coordinate system is a heading angle of the tracked chassis, and the heading angle is positive in the counterclockwise direction from the positive direction of the x-axis. FIGS. 4A-4C are schematic diagrams of a power module of a tracked chassis in an unmanned radish harvesting system provided by the present disclosure. A velocity or power direction of the left and right tracks of the radish harvester during a left turn, straight-line travel, and pivot steering is illustrated in FIGS. 4A-4C.

According to the principle that a velocity is equal to a derivative of displacement, the velocity is resolved in the x-direction and the y-direction. Based on the parallelogram rule of vector decomposition, a kinematical equation of the tracked chassis is as follows:

$$\dot{x} = v cos θ = ( {v}_{r} + {v}_{l} ) cos θ / 2 \qquad ( 1 )$$

$$\dot{y} = v sin θ = ( {v}_{r} + {v}_{l} ) sin θ / 2 \qquad ( 2 )$$

Since the tracked chassis can be regarded as a rigid body structure, the instantaneous rotation of the center points of the left and right tracks at any moment may be considered as circular motion around the same center of circle. Thus, the angular velocity of the center points of the left and right tracks is equal to the angular velocity w of the center point of the chassis. Accordingly, the angular velocity \dot{θ} of the center points of the left and right tracks may be derived as follows:

$$\dot{θ} = w = ( {v}_{r} + {v}_{l} ) / L \qquad ( 3 )$$

where L represents a distance between the center points of the left and right tracks, as shown in FIG. 3.

By integrating the formulas (1) to (3), a kinematical model of the tracked chassis may be derived as follows:

$$\{ \begin{matrix}\dot{x} = ( {v}_{r} + {v}_{l} ) cos θ / 2 \\ \dot{y} = ( {v}_{r} + {v}_{l} ) sin θ / 2 \\ \dot{θ} = ( {v}_{r} - {v}_{l} ) / L\end{matrix} \qquad ( 4 )$$

Regarding unmanned radish harvesting operation, a planned path is usually composed of a series of points. These path points contain information such as the attitude and traveling velocity of the harvesting equipment. If an instrument reaches a point by following, it can be regarded as achieving following along a curved path. The radish harvesting speed is usually below 3 km/h. For low-velocity motion, it is suitable to employ a pure tracking algorithm, with a turning radius ascertained through aggregation. A coordinate system X_{B}-O_{B}-Y_{B} is established (with continued reference to FIG. 3). The coordinates of the center point O_{B} of a track model are denoted by (x, y), and the coordinates of a target point P_{B} are denoted by (xb, yb). To make the tracked chassis move from the point O_{B} to the point P_{B}, a fixed differential velocity of traveling motion is set for the left and right tracks of the tracked chassis, so that the point O_{B} moves to the point P_{B} along an arc-shaped traveling trajectory. The point O_{C} is set as the center of a turning curve.

An included angle between the straight line where the origin of coordinates O_{B} and the target point P_{B} lie and the X_{B} axis is defined as α; LE represents a forward-looking distance for motion preview; R represents the turning radius; and β is defined as an arc angle that the tracked chassis turns from an initial position to the target point. According to a geometric relationship, the following formula is derived:

$$tan α = \frac{{y}_{b}}{{x}_{b}} \qquad ( 5 )$$

The following formulas are derived:

$$α = arctan \frac{{y}_{b}}{{x}_{b}} \qquad ( 6 )$$

$$β = π - 2 α \qquad ( 7 )$$

The target point P_{B} is projected onto the X_{B} axis, and according to the geometric relationship, the following formulas are derived:

$${x}_{b} + R cos β = R \qquad ( 8 )$$

$${x}_{b} + R cos ( π - 2 α ) = R \qquad ( 9 )$$

By integrating the formulas (6) to (9), the turning radius of the tracked chassis is derived as follows:

$$R = \frac{{x}_{b}}{( 1 + cos ( 2 arctan \frac{{y}_{b}}{{x}_{b}} ) )} \qquad ( 10 )$$

Assuming that the contact between the tracked chassis and the ground during motion is pure friction (i.e., no slippage is considered), there is the following inherent relationship between the velocities vₗ, vᵣ of the left and right tracks and the velocity v at the center of the chassis:

$${v}_{l} = \frac{v ( R + \frac{L}{2} )}{R} \qquad ( 11 )$$

$${v}_{r} = \frac{v ( R + \frac{L}{2} )}{R} \qquad ( 12 )$$

By substituting the formula (10) into the formulas (11) and (12), a given value of the differential velocity of the tracks is ultimately obtained as follows:

$$\{ \begin{matrix}{v}_{l} = \frac{v ( \frac{{x}_{b}}{( 1 + cos ( 2 arctan \frac{{y}^{b}}{xb} ) )} + \frac{L}{2} )}{R} \\ {v}_{r} = \frac{v ( \frac{{x}_{b}}{( 1 + cos ( 2 arctan \frac{{y}^{b}}{xb} ) )} - \frac{L}{2} )}{R}\end{matrix} \qquad ( 13 )$$

x_{b} is defined as a lateral error of path tracking, and α is defined as a heading deviation of path tracking. The larger the absolute value of the horizontal coordinate x_{b} of the target point in the coordinate system of the tracked chassis, the greater the lateral distance by which the harvester deviates from the target path. The larger the absolute value of the included angle between the target point and the x-axis of the coordinate system of the tracked chassis, the greater the heading error of the harvester deviating from the target path.

The unmanned radish harvesting control subsystem provided in the embodiment of the present disclosure has addressed the issues of abrupt traveling velocity switching of the original machinery and unstable turning due to single-track locking by improving the forward-backward traveling and left-right steering devices of the radish harvester and by means of soft voltage control in the form of the steering engine. Simultaneously, electronic control is introduced to provide both on-site remote control and remote algorithm control ports, thereby achieving effective control over the radish harvester.

The unmanned radish harvesting operation subsystem includes a ridge alignment navigation and extraction module and a U-turn and row switching module. The ridge alignment navigation and extraction module includes an RTK module and a visual module.

The RTK module is mainly configured to utilize the basic information from the radish cultivation stage and apply the mapping information to the harvesting operation to realize the position recognition of radishes.

The visual module is mainly configured for ridge alignment. By identifying the information of furrow edges, more accurate real-time operation path planning is realized.

Optionally, the visual module is configured to binarize a captured image separately using Hough operator and Otsu's method with adaptive thresholding, process a loss function based on Huber algorithm, and identify a center line of a ridge and boundaries on two sides of the ridge during radish harvesting.

Specifically, when performing radish ridge alignment based on the visual module, the Hough operator and the Otsu's method with adaptive thresholding are used for binarization, and the loss function is processed based on the Huber algorithm to identify and extract the center line of the ridge and the boundaries on two sides of the ridge during radish harvesting, thereby realizing accurate ridge alignment in the radish harvesting operation process.

Optionally, the U-turn and row switching module is configured for path optimization using an elite ant colony algorithm.

Specifically, the U-turn and row switching module is mainly configured to plan a path to a farm track, an edge of a field, and an edge of an operation plot during operation. The elite ant colony algorithm is used for path optimization in the embodiments of the present disclosure.

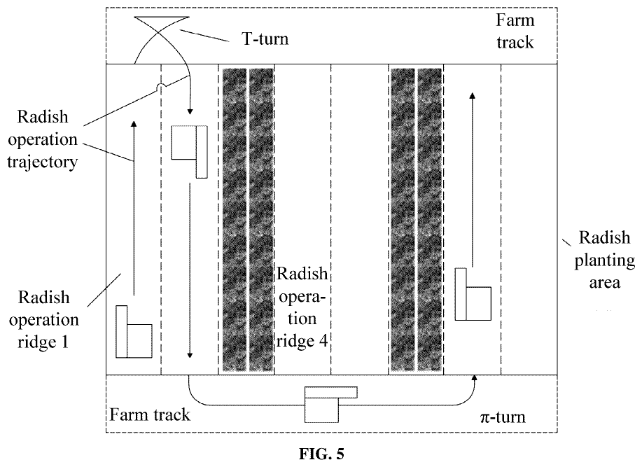

FIG. 5 is a schematic diagram of radish path planning in an unmanned radish harvesting system provided by the present disclosure.

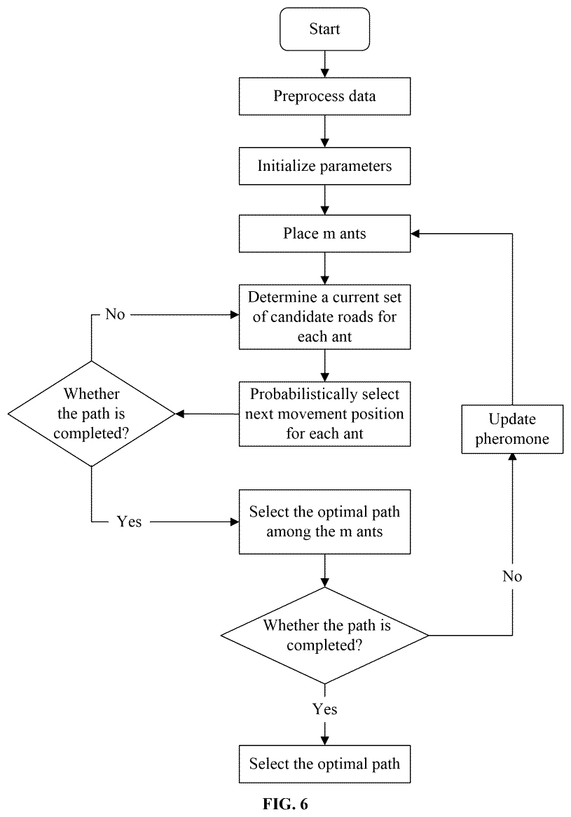

FIG. 6 is a schematic diagram of an elite ant colony algorithm in an unmanned radish harvesting system provided by the present disclosure.

Based on any of the above embodiments, various operators, algorithms, and computer vision models are used in the radish harvesting process, including operation path planning, navigation, obstacle recognition, ridge alignment, clamping and pulling, top cutting, and radish quality inspection. Since models oriented to agricultural production scenarios usually need to have both high accuracy and light weight, the embodiments of the present disclosure are designed in terms of path planning and target detection.

Taking the fruit position detection in the radish clamping and pulling operation as an example, the elite ant colony algorithm is used for path optimization in terms of path planning. In terms of target detection, a segmentation algorithm is used to accurately acquire the target, so as to facilitate rapid feedback and operation by the machine.

Optionally, the unmanned radish harvesting operation subsystem includes a clamping-pulling visual recognition module configured to obtain radish fruits by using an instance segmentation algorithm.

A Yolov8s-seg model is used as a backbone network of a segmentation network of the instance segmentation algorithm; MobileNetv4 is used as a backbone of the Yolov8s-seg model; an SPPF module in the Yolov8s-seg model is replaced with a large separable kernel attention module; and the segmentation network includes an inverted bottleneck search module.

Specifically, the unmanned radish harvesting operation subsystem further includes the clamping-pulling visual recognition module and a visual recognition module for radish fruits and tops. The clamping-pulling visual recognition module is configured to identify clamping and pulling positions of radishes, so as to realize accurate clamping and pulling of radishes. The visual recognition module for radish fruits and tops is configured to identify positions of radish fruits and tops, so as to accurately cut radish tops.

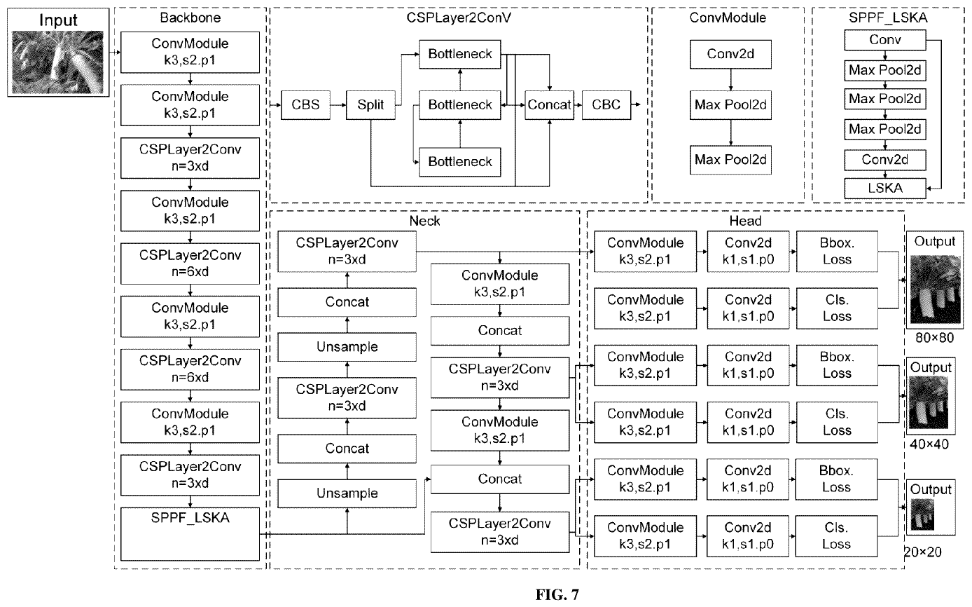

To take recognition accuracy, low latency, and few parameters (i.e., a relatively small number of network parameters) into comprehensive consideration, in the embodiments of the present disclosure, the instance segmentation algorithm Yolov8s-seg, which supports images and videos, is adopted as the backbone network in both the clamping-pulling visual recognition module and the visual recognition module for radish fruits and tops, with further improvements made on this basis. FIG. 7 is a schematic diagram of an improved Yolov8s-seg network structure in an unmanned radish harvesting system provided by the present disclosure.

To enhance the portability of the network, MobileNetv4 is adopted as the backbone in which the flexible inverted bottleneck search module is introduced. Moreover, the inverted bottleneck search module, ConvNext, a feedforward network, and an additional depth-wise separable variant are integrated. The search efficiency of the model is improved by means of an optimized neural architecture search (NAS) configuration. A novel distillation technique is introduced to enhance the model accuracy, and the SPPF module in the Yolov8s-seg model is replaced with the large separable kernel attention (LSKA) module. Thus, the performance of small target detection during operation is enhanced, thereby reducing computational complexity and graphic memory usage.

The unmanned radish harvesting operation subsystem provided in the embodiment of the present disclosure is capable of planning unmanned harvesting operation paths. For radish harvesting plot scenarios, the positions of the radish harvester's own mechanism and the harvesting arm are fused, and the improved ant colony algorithm is adopted for iterative calculation. Before each operation, the starting point and end point of the operation and the path planned with the minimum energy consumption are taken into account, thus realizing the analysis of the minimum energy consumption operation mode for fixed plots. Radish clamping and pulling image recognition can also be carried out. The improved Yolov8s-seg model is employed to recognize the positions of radish fruits in real time. The backbone network is replaced with MobileNetv4, and the SPPF module is replaced with LSKA. This achieves a lightweight model training process with fewer parameters, enhances the performance of small target detection during operation, and reduces computational complexity and graphic memory usage.

In the unmanned radish harvesting system provided by the present disclosure, the radish agronomic parameter configuration subsystem is a key part for the integration of agricultural machinery and agronomy. By inputting agronomic parameters, driving requirements are provided for the harvester. A cultivar parameter configuration module, a cultivation parameter configuration module, and an environmental parameter configuration module are included.

Optionally, the cultivar parameter configuration information includes one or more of:
a radish cultivar;
a fruit size;
a ripening time;
a water requirement for different stages;
a fertilizer requirement for different stages;
a suitable temperature; and
a suitable humidity.

In particular, the cultivar parameter configuration module is mainly configured to input the radish cultivar, the fruit size, the ripening time, the water requirement and fertilizer requirement for different stages, the suitable temperature, and the suitable humidity.

Optionally, the cultivation parameter configuration information includes one or more of:
an overall operation area configuration;
a planting ridge height;
a ridge spacing;
a row spacing;
a plant spacing; and
a cultivation time.

In particular, the cultivation parameters are important in the configuration process, including the information such as the overall operation area configuration, the planting ridge height, the ridge spacing, the row spacing, the plant spacing, and the cultivation time, which can be input as scenario parameters for unmanned operation of the agricultural machinery. For agricultural machinery parameters, a wheel span, an agricultural machinery position, a starting point, and an operation mode are configured.

Optionally, the environmental parameter configuration information includes one or more of:
an air temperature;
an air humidity;
a soil temperature;
a soil humidity;
illumination; and
a soil pH.

In particular, the environmental parameter configuration module is mainly configured to configure the suitable air temperature, air humidity, soil temperature, soil humidity, illumination, and soil pH based on the basic information of the radish cultivar.

Based on any of the above embodiments, in the embodiments of the present disclosure, the computer vision method is adopted to identify the ridge edge lines during operation. For the architecture of the recognition model, reference is made to the improved Yolov8s-seg (with continued reference to FIG. 7). The data input and labels of the model are radish ridge edge lines. In this scenario, the harvesting arm is on the right side. Therefore, it is necessary to identify the left ridge line after ridge alignment. That is, real-time visual correction is performed to ensure the accuracy of the unmanned driving during traveling.

Optionally, the unmanned radish harvesting system further includes an edge server and a cloud server.

A cloud-edge-terminal intelligent service architecture is adopted for the unmanned radish harvesting system; the unmanned radish harvesting control subsystem and the unmanned radish harvesting operation subsystem are implemented by terminals; and big data processing is performed by the edge server and/or the cloud server.

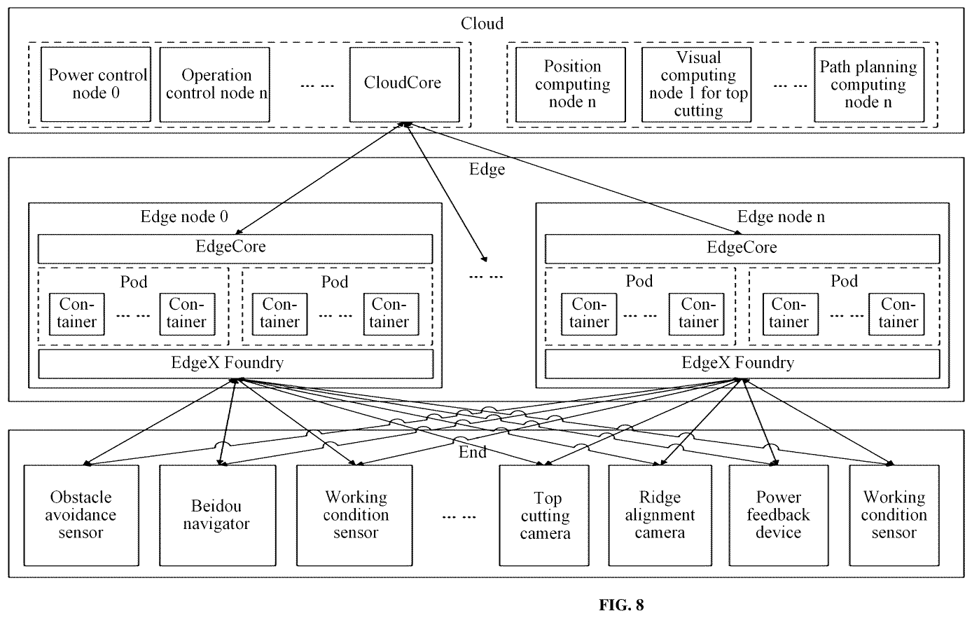

In particular, FIG. 8 is a schematic diagram of a cloud-edge-terminal intelligent processing architecture for radish harvesting in an unmanned radish harvesting system provided by the present disclosure. In the unmanned radish harvesting system according to the embodiments of the present disclosure, a “cloud, edge, and end” collaborative architecture is adopted for model training, data transmission, and model recognition. The model training process usually requires services with high computing power and high processing performance. Therefore, on the “cloud”, this is implemented jointly by a control node of the cloud part Kubernetes and a node run by the edge part KubeEdge. The Kubernetes control node adopts the original data model of the cloud part and maintains the original control and data processes unchanged. That is, the node run by KubeEdge appears as an ordinary node on Kubernetes. Kubernetes can manage the node run by KubeEdge in the same way as it manages the ordinary node. Based on the Kubernetes control node, KubeEdge realizes the sinking of Kubernetes cloud computing-orchestrated containerized applications by CloudCore of the cloud part and EdgeCore of the edge part. Here, after periodically collecting on-site training data, labeling and training are performed as required to generate a trained model, which is then scheduled.

“Edge” and “end” collaboration refers to using KubeEdge as the management program running on the edge node, which is responsible for managing resources loaded during the unmanned operation process on the edge node, the operation status of the operation terminal, faults, and the like. KubeEdge provides the required computing resources for EdgeX Foundry service and is also responsible for managing the entire life cycle of the EdgeX Foundry End service. EdgeX Foundry can collect, filter, store, and mine data from various Internet of Things (IoT) terminal devices via the managed harvesting operation microservice modules, and can also issue instructions to various IoT terminal devices through the managed microservices to control the terminal devices. Model computing power is deployed for production scenarios through edge computing and scenario-based fine-tuning is performed for different tasks. Embedded terminals are connected via a high-bandwidth and low-latency network, including video monitors at various positions, obstacle avoidance terminals, navigation terminals, etc., in the radish harvester.

According to the cloud-edge-terminal intelligent service framework of the unmanned radish harvesting system provided in the embodiments of the present disclosure, during the execution of unmanned operation tasks, the involved sensor, controller, video collector, mechanical pose controller, etc., all comply with the cloud-edge-terminal intelligent service architecture. That is, data is collected by the terminal at the operation site; data analysis and processing with low computing power are completed locally; data is compressed before transmission; and finally, model training with high energy consumption and numerous parameters is carried out on cloud services. By scenario-based adaptive scheduling of the model, the computing power overhead is minimized.

The unmanned radish harvesting system provided in the present disclosure, using the unmanned radish harvesting control subsystem, the unmanned radish harvesting operation subsystem, and the radish agronomic parameter configuration subsystem, allows for intelligent definition and control of the forward and backward movements, direction, and velocity of the radish harvester, and the lifting of the harvesting arm, and optimal operation path planning by integrating the shape and terrain of the vegetable field plot and planting agronomic practices. The computer vision algorithm is integrated in a plurality of processes to accurately identify radish fruits and radish tops. More intelligent, delicate, and accurate operations of the unmanned operation harvester are realized. All models that have been transformed for unmanned operation use the cloud-edge-terminal processing architecture, and the computing power overhead is minimized through scenario-based adaptive scheduling of the models. Thus, human resources, material resources, and time are saved, and the efficiency and quality of unmanned radish harvesting as well as the green and intelligent levels of unmanned radish harvesting are improved.

Through the description of the foregoing embodiments, a person skilled in the art can clearly understand that the embodiments can be implemented by means of software plus a necessary universal hardware platform, or certainly, can be implemented by hardware. Based on such understanding, the foregoing technical solution which is essential or a part contributing to the prior art may be embodied in the form of a software product, the computer software product may be stored in a computer readable storage medium, such as an ROM/RAM, a magnetic disk or an optical disk, including a plurality of instructions for causing a computer device (which may be a personal computer, a server, or a network device) to perform the methods described in the examples or some parts of the examples.

It should be noted that terms “including”, “comprising” or any other variants thereof are intended to cover non-exclusive inclusion such that a process, method, article, or apparatus including a series of elements includes not only those elements but also other elements not explicitly listed, or elements inherent to such a process, method, article, or apparatus. Without further limitation, an element qualified by the phrase “including a . . . ” does not exclude the presence of an additional identical element in the process, method, article, or apparatus including the element. Furthermore, it should be noted that the scope of the methods and devices in the embodiments of the present disclosure is not limited to performing functions in the order shown or discussed. The involved functions may also be performed in a substantially simultaneous manner or in the reverse order. For example, the described methods may be performed in an order different from that described, and various steps may be added, omitted, or combined. In addition, features described with reference to certain examples may be combined in other examples.

The expression “determining B based on A” in the embodiments of the present disclosure means that factor A shall be considered when determining B. It is not limited to “determining B only based on A”, but shall also include: “determining B based on A and C”, “determining B based on A, C, and E”, “determining C based on A, and further determining B based on C”, etc. In addition, it may also include taking A as a condition for determining B. For example, “when A meets the first condition, the first method is used to determine B”. For another example, “when A meets the second condition, β is determined”. For yet another example, “when A meets the third condition, β is determined based on the first parameter”, etc. Certainly, it may also be taking A as a condition for the factor of determining B. For example, “when A meets the first condition, the first method is used to determine C, and β is further determined based on C”, etc.

In the present disclosure, the term “a plurality of” refers to two or more, and other quantifiers have similar meanings.

Finally, it should be noted that the foregoing embodiments are only used to illustrate the technical solutions of the present disclosure, and are not intended to limit the present disclosure. Although the present disclosure is described in detail with reference to the foregoing embodiments, those of ordinary skill in the art should understand that they can still modify the technical solutions described in the foregoing embodiments, or make equivalent substitutions to some technical features therein. These modifications or substitutions do not make the essence of the corresponding technical solutions depart from the spirit and scope of the technical solutions in the embodiments of the present disclosure.

What is claimed is:

1. An unmanned radish harvesting system, comprising: an unmanned radish harvesting control subsystem, an unmanned radish harvesting operation subsystem, and a radish agronomic parameter configuration subsystem,
wherein the unmanned radish harvesting control subsystem comprises an unmanned movement control module and an unmanned radish harvesting module;
the unmanned movement control module comprises a remote control module, a wireless communication system, a Beidou satellite positioning system, and an electric tracked chassis;
the unmanned radish harvesting module is configured to control a height using an included angle sensor and deduce heights of an operation platform and a ridge from an included angle between the operation platform and the ridge;
the unmanned radish harvesting operation subsystem comprises a ridge alignment navigation and extraction module and a U-turn and row switching module; the ridge alignment navigation and extraction module comprises a real-time kinematic (RTK) module configured to apply mapping information in harvesting operation by utilizing radish agronomic parameter information to realize position recognition of radishes, and a visual module configured to align ridges through identification of furrow edge information and realize real-time operation path planning; the U-turn and row switching module is configured to plan a path to a farm track, an edge of a field, and an edge of an operation plot during operation;
the radish agronomic parameter configuration subsystem comprises a cultivar parameter configuration module configured to obtain cultivar parameter configuration information, a cultivation parameter configuration module configured to obtain cultivation parameter configuration information, and an environmental parameter configuration module configured to obtain environmental parameter configuration information;
the unmanned radish harvesting operation subsystem comprises a clamping-pulling visual recognition module configured to obtain radish fruits by using an instance segmentation algorithm;
a Yolov8s-seg model is used as a backbone network of a segmentation network of the instance segmentation algorithm; MobileNetv4 is used as a backbone of the Yolov8s-seg model; a spatial pyramid pooling-fast (SPPF) module in the Yolov8s-seg model is replaced with a large separable kernel attention module; and the segmentation network comprises an inverted bottleneck search module; and
the visual module is configured to binarize a captured image separately using Hough operator and Otsu's method with adaptive thresholding, process a loss function based on Huber algorithm, and identify a center line of a ridge and boundaries on two sides of the ridge during radish harvesting.

2. The unmanned radish harvesting system according to claim 1, wherein the unmanned movement control module comprises an unmanned velocity control module and an unmanned steering control module; the unmanned velocity control module is configured for soft voltage regulation and control in the form of a steering engine; and the unmanned steering control module is controlled by using a proportional valve.

3. The unmanned radish harvesting system according to claim 1, wherein the U-turn and row switching module is configured for path optimization using an elite ant colony algorithm.

4. The unmanned radish harvesting system according to claim 1, further comprising an edge server and a cloud server,
wherein a cloud-edge-terminal intelligent service architecture is adopted for the unmanned radish harvesting system; the unmanned radish harvesting control subsystem and the unmanned radish harvesting operation subsystem are implemented by terminals; and big data processing is performed by the edge server and/or the cloud server.

5. The unmanned radish harvesting system according to claim 1, wherein the cultivation parameter configuration information comprises one or more of:
an overall operation area configuration;
a planting ridge height;
a ridge spacing;
a row spacing;
a plant spacing; and
a cultivation time.

6. The unmanned radish harvesting system according to claim 1, wherein the cultivar parameter configuration information comprises one or more of:
a radish cultivar;
a fruit size;
a ripening time;
a water requirement for different stages;
a fertilizer requirement for different stages;
a suitable temperature; and
a suitable humidity.

7. The unmanned radish harvesting system according to claim 1, wherein the environmental parameter configuration information comprises one or more of:
an air temperature;
an air humidity;
a soil temperature;
a soil humidity;
illumination; and
a soil pH.
